(19) United States
(12) Patent Application Publication
(10) Pub. No.: US 2021/0173855 A1
(43) Pub. Date: Jun. 10, 2021

(54) METHOD, APPARATUS, AND COMPUTER PROGRAM PRODUCT FOR DYNAMIC POPULATION ESTIMATION

(71) Applicant: HERE Global B.V., Eindhoven (NL)

(72) Inventors: Xiang LIU, Berlin (DE); Philo POLLMANN, Berlin (DE); Dmitry KOVAL, Berlin (DE)

(21) Appl. No.: 16/708,777

(22) Filed: Dec. 10, 2019

(51) Int. Cl. G06F 16/29; H04W 4/021; H04W 4/029; G08G 1/01; G06Q 50/26

(52) U.S. Cl. CPC G06F 16/29; H04W 4/021; G06Q 50/26; G08G 1/0129; H04W 4/029

(57) ABSTRACT

Provided herein is a method for identifying a probability of observing a predetermined number of people within a geographic area. Methods may include: receiving static population data including a population count associated with each of a plurality of geographical areas of a geographic region, where static population data is updated no more frequently than a predefined frequency; receiving dynamic population data for the geographic region including the plurality of geographical areas, where dynamic population data is updated more frequently than the predefined frequency; associating the dynamic population data with geographic sub-areas of the geographic region and times in which the dynamic population data was received; and calculating, from the static population data and the dynamic population data, a probability of observing a predefined number of people within each geographic sub-area for a specific time.

### TECHNOLOGICAL FIELD

Example embodiments described herein relate generally to identifying the probability of observing a predetermined number of people within a geographic area, and more particularly, to dynamically estimating the probability of observing a predetermined number of people of finite geographic regions based on modeling using an amalgamation of data sources.

### BACKGROUND

Population estimation for a region is difficult based on the unique behavior of individuals within a population and often unpredictable movement. Census data provides population estimates for a region; however, census data is generally periodic, static population counts. Thus, census data only provides a static snapshot of population information. Further, census data does not provide information regarding where people actually are and instead relies upon residential addresses to establish head counts.

Population data is valuable for a variety of reasons ranging from democratic representation of a population to identifying where people are in order to target advertising. Further, population data over time reveals migratory patterns of people through a region. More frequent population data that changes over shorter periods of time may further be useful for a variety of reasons, including the planning of roadways or public transit, among other uses.

### BRIEF SUMMARY OF EXAMPLE EMBODIMENTS

At least some example embodiments are directed to identifying a probability of observing a predetermined number of people within a geographic area. Embodiments may provide an apparatus including at least one processor and at least one memory including computer program code. The at least one memory and the computer program code may be configured to, with the processor, cause the apparatus to at least: receive static population data including a count associated with each of a plurality of geographical areas of a geographic region, where static population data is updated no more frequently than a predetermined frequency; receive dynamic population data for the geographic region including the plurality of geographical areas, where dynamic population data is updated more frequently than the predefined frequency; associate the dynamic population with geographic sub-areas of the geographic region and times in which the dynamic population data was received; and calculate, from the static population data and the dynamic population data, a probability of observing a predefined number of people within each geographic sub-area for a specific time.

According to some embodiments, the geographical areas do not correspond with the geographic sub-areas, where the apparatus may further be caused to: re-associate the static population data from the plurality of geographical areas with the geographic sub-areas, where causing the apparatus to calculate, from the static population data and the dynamic population data, population estimates for the geographic sub-areas includes causing the apparatus to calculate, from the static population data re-associated with the geographic sub-areas and the dynamic population data associated with the geographic sub-areas, a probability of observing a predefined number of people within each geographic sub area. The dynamic population data includes at least one of: mobile device probe data, vehicle probe data, social media check-in data, traffic data, or camera image data. The static population data for the geographical areas may include census data for the geographical areas.

The apparatus of some embodiments may be caused to: generate population estimates for the geographic sub-areas based on the probability of observing a predefined number of people within the geographic sub-areas; and generate a graphical user interface of the geographic region, where the graphical user interface presents the geographic sub-areas of the geographic regions and provides an indication of the population estimates for the geographic sub-areas. The indication of the population estimates for the geographic sub-areas provides an indication of the specific time of the respective population estimates for the geographic sub-areas. Causing the apparatus to calculate, from the static population data and the dynamic population data, a probability of observing a predefined number of people within each geographic sub-area may include causing the apparatus to model the population probabilities based on Bayesian processing using Dirichlet modeling of the static population data and the dynamic population data. Causing the apparatus to receive dynamic population data for a geographic region may include causing the apparatus to: receive dynamic population data for the geographic region from a plurality of data sources; identify dynamic population data representing other than a single person; and transform the dynamic population data representing other than a single person to correspond to an estimated number of people associated with the dynamic population data representing other than a single person.

Embodiments provided herein may include a computer program product having at least one non-transitory computer-readable storage medium having computer-executable program code instructions stored therein. The computer-executable program code instructions may include program code instructions to: receive static population data including a population count associated with each of a plurality of geographical areas of a geographic region, where static population data is updated no more frequently than a predefined frequency; receive dynamic population data for the geographic region including the plurality of geographical areas, where dynamic population data is updated more frequently than the predefined frequency; associate the dynamic population data with geographic sub-areas of the geographic region and times in which the dynamic population data was received; and calculate, from the static population data and the dynamic population data, a probability of observing a predefined number of people within each geographic sub-area for a specific time.

According to some embodiments, the geographical areas may not correspond with the geographic sub-areas. In such a case, the computer program product may further include program code instructions to: re-associate the static population data from the plurality of geographical areas with the geographic sub-areas, where the program code instructions to calculate, from the static population data and the dynamic population data, population estimates for the geographic sub-areas includes program code instructions to calculate, from the static population data re-associated with the geographic sub-areas and the dynamic population data associated with the geographic sub-areas, a probability of observing a predefined number of people within each geographic sub-area. The dynamic population data may include at least one of: mobile device probe data, vehicle probe data, social media check-in data, traffic data, or camera data. The static population data for the geographical areas may include census data for the geographical areas.

Embodiments may include program code instructions to: generate population estimates for the geographic sub-areas based on the probability of observing a predefined number of people within the geographic sub-areas; and generate a graphical user interface of the geographic region, where the graphical user interface presents the geographic sub-areas of the geographic regions and provides an indication of the population estimate for the geographic sub-areas. The indication of the population estimate for the geographic sub-areas provides an indication of the specific time of the respective population estimates for the geographic sub-areas. The program code instructions to calculate, from the static population data and the dynamic population data, a probability of observing a predefined number of people within each geographic sub-area may include program code instructions to model the population probabilities based on Bayesian processing using Dirichlet modeling of the static population data and the dynamic population data. The program code instructions to receive dynamic population data for a geographic region may include program code instructions to: receive dynamic population data for the geographic region from a plurality of data sources; identify dynamic population data representing other than a single person; and transform the dynamic population data representing other than a single person to correspond to an estimated number of people associated with the dynamic population data representing other than a single person.

Embodiments provided herein may include a method including: receiving static population data including a population count associated with each of a plurality of geographical areas of a geographic region, where static population data is updated no more frequently than a predefined frequency; receiving dynamic population data for the geographic region including the plurality of geographical areas, where dynamic population data is updated more frequently than the predefined frequency; associating the dynamic population data with geographic sub-ares of the geographic region and times in which the dynamic population data was received; and calculating, from the static population data and the dynamic population data, a probability of observing a predefined number of people within each geographic sub-area for a specific time.

According to some embodiments, the geographical areas do not correspond with the geographic sub-areas, where methods may further include: re-associating the static population data from the plurality of geographical areas with the geographic sub-areas, where calculating, from the static population data and the dynamic population data, probabilities for observing a predefined number of people for the geographic sub-areas includes calculating, from the static population data re-associated with the geographic sub-areas and the dynamic population data associated with the geographic sub areas, a probability of observing a predefined number of people within each geographic sub-area. The dynamic population data may include at least one of: mobile device data, vehicle probe data, social media check-in data, traffic data, or camera image data. The static population data for the geographical areas include census data for the geographical areas.

Embodiments provided herein may include an apparatus including: means for receiving static population data including a population count associated with each of a plurality of geographical areas of a geographic region, where static population data is updated no more frequently than a predefined frequency; means for receiving dynamic population data for the geographic region including the plurality of geographical areas, where dynamic population data is updated more frequently than the predefined frequency; means for associating the dynamic population data with geographic sub-ares of the geographic region and times in which the dynamic population data was received; and means for calculating, from the static population data and the dynamic population data, a probability of observing a predefined number of people within each geographic sub-area for a specific time.

According to some embodiments, the geographical areas do not correspond with the geographic sub-areas, where apparatuses may further include: means for re-associating the static population data from the plurality of geographical areas with the geographic sub-areas, where the means for calculating, from the static population data and the dynamic population data, probabilities for observing a predefined number of people for the geographic sub-areas includes means for calculating, from the static population data re-associated with the geographic sub-areas and the dynamic population data associated with the geographic sub areas, a probability of observing a predefined number of people within each geographic sub-area. The dynamic population data may include at least one of: mobile device data, vehicle probe data, social media check-in data, traffic data, or camera image data. The static population data for the geographical areas include census data for the geographical areas.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates a bock diagram of the integration of static population data and dynamic data to model and identify a probability of observing a predetermined number of people within a geographic area according to an example embodiment of the present disclosure;

FIG. 4 depicts a user interface heat map for presenting dynamic population estimates according to an example embodiment of the present disclosure;

FIG. 5 illustrates the user interface heat map of FIG. 4 including a timeline bar graph of dynamic population estimates according to an example embodiment of the present disclosure;

FIG. 6 illustrates the user interface heat map of FIG. 5 including source data information for dynamic population estimates according to an example embodiment of the present disclosure; and

FIG. 7 is a flowchart of another method for establishing the dynamic population estimate for a geographic region according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus and computer program products are provided in accordance with an example embodiment in order to dynamically estimate the probability of observing a predetermined number of people within finite geographic sub-areas of a geographic region based on a plurality of data sources. Census data can only provide a snapshot of population information for geographical areas of a geographic region. However, dynamic population estimation for finite geographic sub-areas including temporal population shifts and movement can be useful to a variety of industries. Further, geographical areas may not correspond with geographic sub-areas. For example, a geographical area for static population data may include a zip code, a city, a county boundary, etc. A geographic sub-area may be more narrow, such as a neighborhood, or a building within a city, for example. Dynamic population estimation may be useful for identifying locations for advertising, planning mass transit (e.g., routes and stops), evaluating locations for alternative transportation clustering (e.g., ride-share vehicles, bicycle/scooter stations, etc.), identifying emergency service coverage areas and needs, residential planning, etc. According to example embodiments described herein, the wide availability of mobility data can be fused with census data and modeled to provide dynamic population estimation and prediction for finite geographic regions or zones. Embodiments combine dynamic input data and static data to estimate the probability of a person being within an area rather than providing a definitive headcount in the area. This concept provides a nanocensus service that solves the prediction problem of how many people will be in a given area at a given time.

Dynamic data may be generated by an identified location of a probe which may take the form of a device that can report location. Dynamic data is data that is regularly changing and is updated frequently, such as in real-time or periodically in terms of seconds, minutes, or hours, typically. An instance of probe information/data may comprise, among other information, location information/data, heading information/data, etc. For example, the probe information/data may comprise a geophysical location (e.g., latitude and longitude) indicating the location of the probe apparatus at the time that the probe information/data is generated and/or provided (e.g., transmitted). The probe information/data may optionally include a heading or direction of travel. In an example embodiment, an instance of probe information/data may comprise a probe identifier identifying the probe apparatus that generated and/or provided the probe information/data, a timestamp corresponding to when the probe information/data was generated, and/or the like. Further, based on the probe identifier and the timestamp, a sequence of instances of probe information/data may be identified. For example, the instances of probe information of data corresponding to a sequence of instances of probe information/data may each comprise the same probe identifier or an anonymized identifier indicating that the data is from the same, anonymous probe. In an example embodiment, the instances of probe information/data in a sequence of instances of probe information/data are ordered based on the timestamps associated therewith to form a path.

The gathered dynamic population data may be associated with geographic sub-areas of a geographic region. Associating the dynamic population data with a geographic sub-area may include matching a location of the gathered dynamic population data with the area represented by a geographic sub-area. As dynamic population data may have a discrete location associated with each data point, each data point may be individually available to associate with any arbitrary geographic division generated, such that a geographic sub-area boundary may be established and the dynamic population data within that boundary at a specific time period is associated with that geographic sub-area. Static population data may be associated with a geographic area, such as a city, county, zip code, etc. as described above. The static population may be associated with the geographic area based on the location of the identified population, such as the residential addresses of a population. This geographic areas of static population data may not correspond to the geographical sub-areas of dynamic population data as the geographical sub-areas may be smaller and more focused. In such cases, when using a combination of static population data and dynamic population data, the static population data may require re-association from the geographical areas to the geographic sub-areas. Such re-association may be performed based on housing density within a geographical area used to estimate how to divide and re-associate the static population data with geographical sub-areas. Other techniques may be used to sub-divide geographical areas in order to re-associate static population data of the geographical area to a geographic sub-area in order to generate more precise estimates of population probability within the smaller geographic sub-areas.

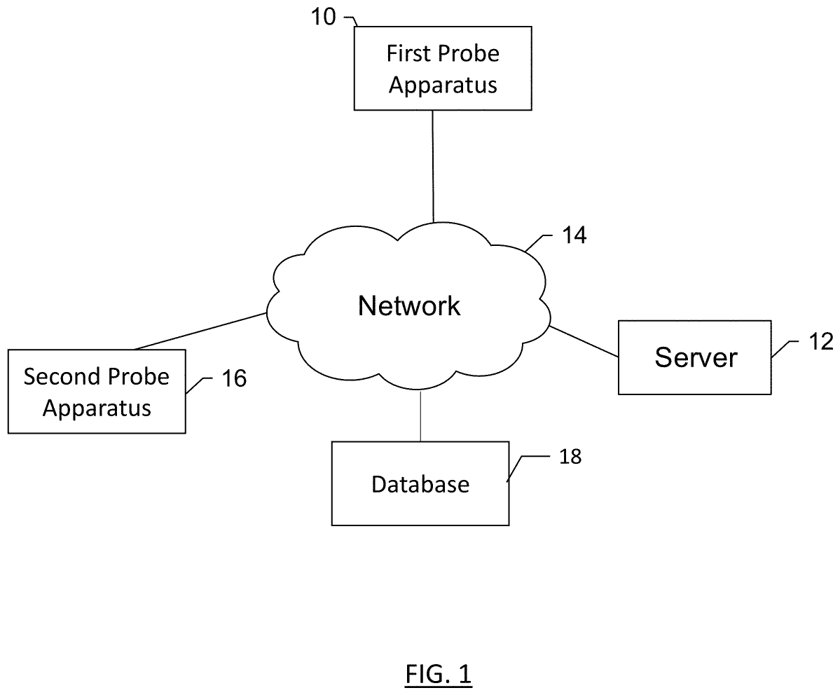

Referring now of FIG. 1, a system that supports communication, typically wirelessly, between a first probe apparatus 10, a second probe apparatus 16, a database 18, and a server 12 or other network entity (hereinafter generically referenced as a “server”) is illustrated. As shown, the probe apparatuses, database, and the server may be in communication via a network 14, such as a wide area network, such as a cellular network or the Internet or a local area network. However, the user devices and the server 12 may be in communication in other manners, such as via direct communications between a probe apparatus (e.g. probe apparatus 10 or 16) and the server 12, or direct communications between the probe apparatuses 10 and 16.

The probe apparatuses 10 and 16 may be embodied by a number of different devices including mobile computing devices, such as a personal digital assistant (PDA), mobile telephone, smartphone, laptop computer, tablet computer, vehicle navigation system, infotainment system, in-vehicle computer, or any combination of the aforementioned, and other types of voice and text communications systems. The server 12 may also be embodied by a computing device and, in one embodiment, is embodied by a web server. Additionally, while the system of FIG. 1 depicts a single server and two probe apparatuses, the system may include any number of servers and probe apparatuses, which may operate independently or collaborate to support activities of the probe apparatuses.

The database 18 may include one or more databases and may include information such as a map database in which geographic information may be stored relating to road networks, points-of-interest, buildings, etc. Further, the database may store therein static population data, such as census data relating to populations of geographical areas of a geographic region. The static population information may be provided by, for example, a municipality or governmental entity. The database may also include historical dynamic population data, such as historical traffic data, mobile device data, monitored area data (e.g., closed-circuit television), or the like. Thus, the database 18 may be used to facilitate the generation of dynamic probabilities of observing a predetermined number of people within a geographic area in conjunction with the server 12 and probe apparatuses 10 and 16.

Static population data, as described herein, may include data that is not real-time data and is only updated on a periodic basis. For example, census data may be updated every ten years, or census estimates may be generated every year to produce static population data for geographical areas of a geographic region. Static data may include data other than census data, such as a population count of a neighborhood, building, or city that may be updated weekly, monthly, or annually, for example. Static data may be generated by a variety of means; however, static population data generally includes establishing population count based on residential addresses of the population such that the static population data does not reflect any movement of the population during a day/month/year. Static population may include population data that is updated only periodically, and less frequently than a predefined amount of time, such as weekly, monthly, yearly, or longer. Further, static population data may be generated for a geographic region and the static population data may be broken down within that region into geographical areas. These geographical areas may correspond to boundaries such as zip codes, cities, counties, or other defined boundaries, for example.

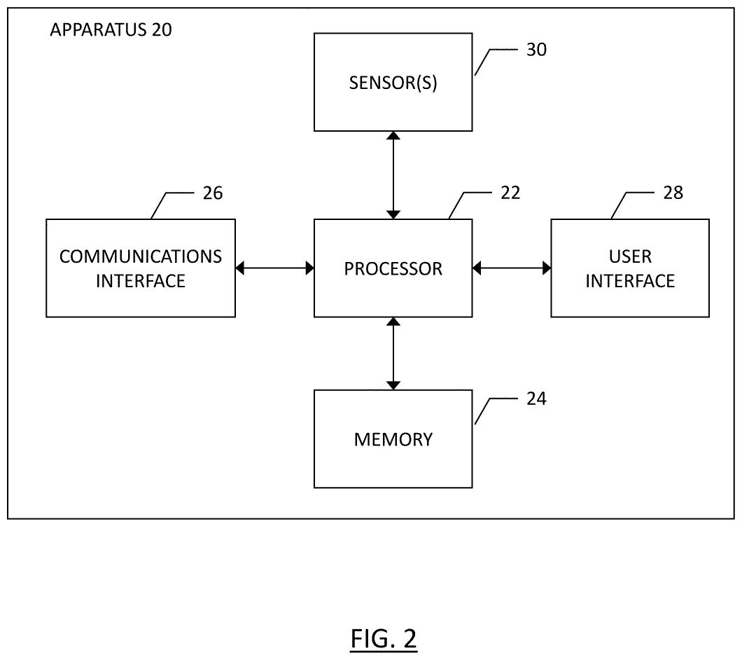

Regardless of the type of device that embodies the probe apparatuses 10 or 16, the probe apparatuses may include or be associated with an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. user device 10 or 16) and a server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the server 12 and user devices 10 or 16. The communications interface 26 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

The apparatus 20 of example embodiments may further include one or more sensors 30 which may include location sensors, such as global positioning system (GPS) sensors, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a probe apparatus, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing dynamic population estimates for geographic sub-areas within a map as described further below. Embodiments of the user device may include components similar to those as shown in FIG. 2 through which a user may interact with dynamic population data presented on the display of a user interface for a device, such as apparatus 20.

Embodiments described herein relate to identifying the probability of observing a predetermined number of people within a geographic area, and more particularly, to dynamically estimating the probability of observing a predetermined number of people of finite geographic sub-areas based on modeling using an amalgamation of data sources. By fusing available static and dynamic data sources, a probability of observing a given number of persons in a given area may be produced. The results of such predictions may be provided in a visual representation on a user interface and made user-friendly through a service that provides dynamic population estimation for consumption by various industries and applications that may benefit from dynamic population estimation using a probability that a predetermined number of people will be observed in an area. Spatial areas of interest may be arranged, for example, in hexagonal cells which may aid in finding smoother paths from cell to cell while offering complete coverage of a geographic region. Dynamic population predictions may be made per individual cell, while larger areas can be handled by adding the contents of adjoining cells within the larger area.

Static population data may be received from sources such as a census bureau, local, regional, or national governmental entities, or private population data collection/estimation services. This static population data may be indicative of a primary location of individuals of a population, such as their residential address. This data, while useful, does not provide sufficient detail with regard to the fluidity of the movement of people throughout a day, week, month, season, or year, for example.

Dynamic population data may be gathered through various sources. For example, probe data from probes 20 may be collected from user's mobile devices such as cell phones which can report location and movement of a user. This data may be real-time probe data or historical probe data from users. Other probes such as probes associated with vehicles may provide traffic data, which may also be real-time or historical traffic data. Historical traffic data can be considered dynamic population data as it tracks the ebb and flow of a population as it moves over short periods of time and for specific time instances. Thus, it is not static population data identifying a static, unchanging location of a person. Probe data provides accurate location through locationing mechanisms employed by the probes, which may include GPS sensors, wireless fingerprinting, access point identifiers, etc. Other dynamic population data may be collected through social media, such as through user check-ins at locations, users self-identifying locations or enabling location access within social media, attendance at events identified within social media, or the like.

Still further, dynamic population data may be provided by devices monitoring specific locations, such as closed-circuit television cameras or security cameras that capture individuals in the field of view and may recognize individual people through image recognition software to provide a count of population in a field of view or a count of population passing through a field of view, such as in a particular direction to capture movement of the population toward or away from a location. Dynamic population data may also be established by cameras on roadways such as at toll points along a roadway, along a road segment, or at an intersection. Other devices may be used to identify dynamic population such as near-field communication stations, such as radio-frequency identification antennas that may read the presence of a person through their identification, their mobile device, a key card, etc. Thus, data regarding dynamic population may be gathered from a wide variety of devices using infrastructure that is presently in place.

Using dynamic population data, in combination with static population data, to generate a probability of observing a predefined number of people within a geographic sub-area at any given time may have an accuracy and quality defined by the frequency with which the dynamic population data is updated. For example, dynamic population data updated every hour may not provide sufficient granularity to generate an accurate probability of observing a predefined number of people within a geographic sub-area in fifteen minute increments. Increasing the frequency of update of the dynamic population data may increase the accuracy of the population probability estimates and allow the analysis and review of population data within finer epochs. However, the frequency of dynamic population data updates may be balanced with bandwidth, storage capacity, processing capacity, or the like against the benefits of more frequently updated data.

While dynamic population data may provide a robust indicator of the presence of people, dynamic population data may also provide too much data and may result in individuals being counted multiple times by different devices, such as a user traveling in a vehicle functioning as a probe while also carrying a mobile device functioning as a probe.

The fusion of static population data and dynamic population data sources as described in example embodiments herein may provide a robust and reliable estimate of a probability of a predetermined number of people being observed for a finite geographical region or area. Further, embodiments provided herein may include a graphical user interface available for user analysis and manipulation to deep-dive population numbers for finite geographic areas.

Processing population count data collected through different means may require an approach that can make reasonable predictions about the amount of people in very small geographic sub-areas. Different data sources may provide different population probability estimations and may have different degrees of reliability and accuracy based on the features of an area within which a population is being evaluated. For example, probe data points from mobile devices may be reliable and relatively accurate when a population is in an open area with few obstructions, such as in a park or a suburban residential area. However, some areas may have rather sparse coverage, with few or no mobile devices providing probe data. For example, in dense urban environments, mobile devices within tall buildings may not provide probe data or may not provide reliable probe data. Further, in areas of poor signal coverage, mobile devices may not be able to report probe data. In other cases, a population may be over-estimated such as when one person who carries one or more smart phones or connected devices and is traveling in a connected vehicle sending probe data, and may be checked-in on social media. In such an embodiment, that single person may be counted three, four, five or more times based on their connected devices functioning as probes to generate probe data. In order to forecast a probability of observing population density at any given cell representing a geographic area, embodiments of the present disclosure may be implemented.

Population data from dynamic data sources may be able to capture movement of persons from one area to another; however, probe data from dynamic data sources may be anonymized to preclude this depending on national or regional laws relating to data privacy, or due to user preferences with regard to data sharing. Probe data from dynamic data sources is not configured to be able to identify individuals; however, probe data may include random identifiers to identify data source which may enable differentiation between different data source types.

Embodiments of the present disclosure use a geospatial partition scheme to segment a geographic region into small sub-areas. Arbitrary geometry boundaries, a city, or a particular spatial area may be partitioned into sub-areas. The probability that a predefined number of people would be observed in a given geographic sub-area may be dynamic in that it changes over time. The probability estimate for a given area is not only broken down by geographic segments and sub-areas, but segmented temporally. A temporal partition scheme may be used, such as fifteen minute or one-hour time bins, for example. Embodiments provided herein establish dynamic population probability estimates to estimate the probability of observing a predetermined number of people for a given time instant (t) within sub-area (k) as q_{t,k} for all sub-areas and all time instants.

Rather than estimating the population q_{t,k} directly, embodiments estimate the probability p_{t,k} of seeing a person in the sub-area (k) at the time instant (t). If the total population qₜ in the interested spatial area at the time instant (t) is known, the expected population q_{t,k} can be easily derived from p_{t,k} by q_{t,k}=p_{t,k}qₜ.

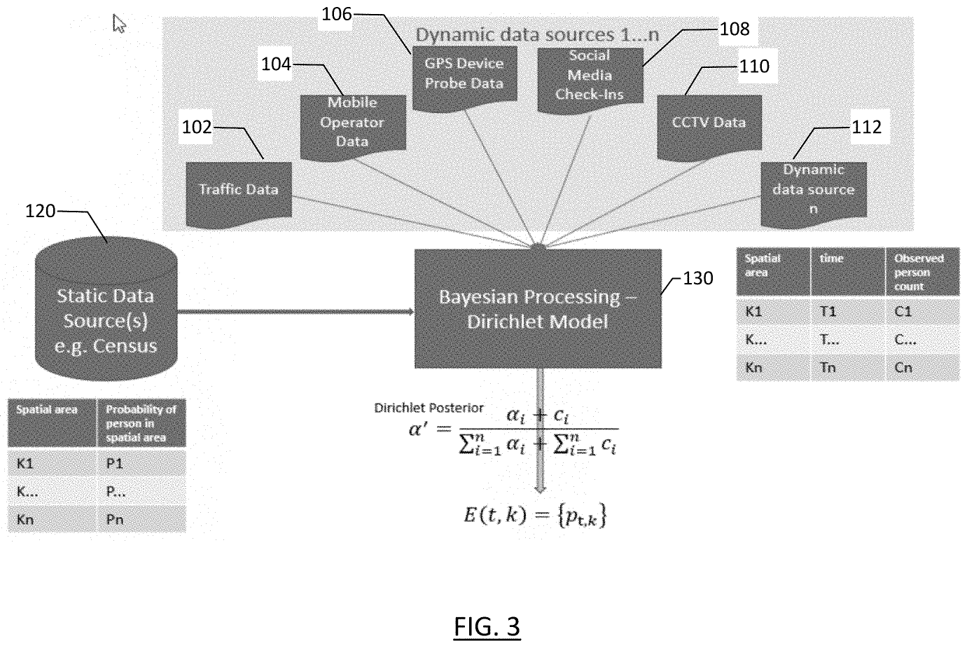

To this end, the processing used to generate the predictions can be summarized as illustrated in FIG. 3. Dynamic data sources 1 . . . n are illustrated to include traffic data 102, mobile operator data 104 (e.g., cell phone provide data), GPS device probe data 106, social media check-ins 108, closed-circuit television data 110, and other dynamic data sources 112. Each of these dynamic data sources provides data to a model 130 for establishing dynamic population probabilities for observing a predetermined number of people within a geographic sub-area. In addition to the dynamic data sources, static population data is provided from a database 120. The static population data may be in the form of census data, governmental/municipal data, building information (e.g., number of residents in a high rise), etc. The static population data is data reflecting a population of a building, area, or region that does not change during a day, and may only be updated periodically, such as weekly, monthly, yearly, or as in the case of a census, every ten years.

Dynamic/mobility data may not be representative of a number of people in a given geographic sub-area. For example, a vehicle may include more than one person, and a person may be identified by multiple devices (e.g., mobile phone, vehicle, social media check-ins, etc.). U.S. patent application Ser. No. 16/417,055, filed on May 20, 2019 entitled “Estimation of Mobile Device Count” and incorporated herein by reference, discloses a method by which mobility data is disambiguated to estimate a population count relative to mobility data.

According to an example embodiment provided herein, the dynamic/mobility data from each source (source i) are binned into all sub-areas at all time instants: c_{i,t,k}. These are binned counts c_{i,t,k} from mobility data that implies the number of observed persons. When a single observation does not correspond to a single person, the mobility data may be transformed to the number of persons. Conditioned on the probability p_{t,k}, the mobility data may be modeled using a categorical distribution, such as:

(Σᵢ₌₁^{I}c_{i,t,1}, . . . ,Σᵢ₌₁^{I}c_{i,t,K}|p_{t,1}, . . . p_{t,K})˜Cat(p_{t,1}, . . . ,p_{t,K})

Where I is the number of data sources and Cat(⋅) is the categorical distribution. Here the sub-areas are viewed as categories.

In Bayesian statistics, the conjugate prior distribution of the categorical distribution is the Dirichlet distribution. The census population may be used for deriving the conjugate prior distribution for the above binned counts from mobility data. Since the census population is typically spatially partitioned in a different scheme than the given partitions of sub-areas described herein, the census population may be first redistributed into the given sub-areas: αₖ. The redistributed census population αₖ is viewed as the pseudocount, so that the conjugate prior distribution is:

(p_{t,1}, . . . ,p_{t,K}|α₁, . . . ,α_{K})˜Dir(α₁, . . . ,α_{K})

Where Dir(⋅) is the Dirichlet distribution.

The posterior distribution is also the Dirichlet distribution:

$$( {p}_{t , 1} , … , {p}_{t , K} \vert {c}_{1 , t , 1} , … , {c}_{1 , t , K} , {c}_{2 , t , 1} , … , {c}_{I , t , K} , {α}_{1} , … , {α}_{K} ) \text{∼} Dir ( {α}_{1} + {\sum }_{i = 1}^{I} {c}_{i , t , 1} , … , {α}_{s} + {\sum }_{i = 1}^{I} {c}_{i , t , K} )$$

Hence, the expected probability of the posterior distribution is:

$$E \{ {p}_{t , k} \vert {c}_{1 , t , 1} , … , {c}_{1 , t , K} , {c}_{2 , t , 1} , … , {c}_{I , t , K} , {α}_{1} , … , {α}_{K} \} = \frac{{α}_{k} + {\sum }_{i = 1}^{I} {c}_{i , t , k}}{{\sum }_{k = 1}^{K} {α}_{k} + {\sum }_{i = 1}^{I} {\sum }_{k = 1}^{K} {c}_{i , t , k}}$$

If the total population q_{t,k} can be easily derived from p_{t,k} by q_{t,k}=p_{t,k}qₜ. It is also possible to use the other statistics (e.g., mode of the posterior distribution for deriving the population q_{t,k}.

Using the technique described above, a population probability may be generated to identify a probability of observing a predefined number of people within a geographic sub-area. This population probability may be used to generate a population estimate for a geographic sub-area, and a population density estimate can be visualized as a discrete heatmap. The visualization of some example embodiments may be based on hexagonal partitions of the geographical area into hexagonal sub-areas. These hexagonal cells representing the sub-areas provide smoother paths from cell to cell while offering complete coverage. In this way, adjacent cells always share an edge, rather than a square grid in which a path from one cell to another may be through a vertex diagonally between cells that do not share an edge. However, any type of regular geographical partition could be used and serve as a basis for the calculation of population estimates. Further, calculations for irregular geographical partitions could be performed by aggregating the results of finer, regular geometric partitions.

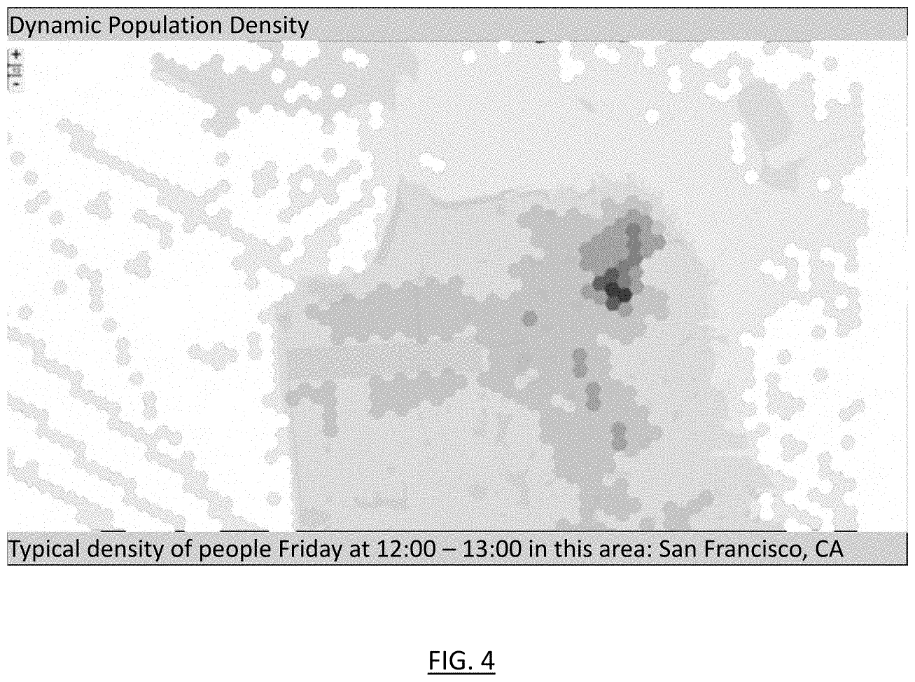

FIG. 4 illustrates an example embodiment of a heat map illustrating dynamic population density displayed for a plurality of hexagonal sub-areas, with the darker shades representing higher population density. As shown, the heat map is not only for population estimates of each of the geographic sub-areas, but also for a time period or instant, which in the illustrated embodiment is “Friday at 12:00-13:00”. Such a time could represent the daytime population of a region where many people are at work rather than at home, such that the population may concentrate in a business district or industrial area, while suburbs and residential areas may be less populated than would be suggested by static census data. Conversely, a dynamic population estimate at 4:00 am-5:00 am may more closely align with static census population data as the majority of people will be at their residential address.

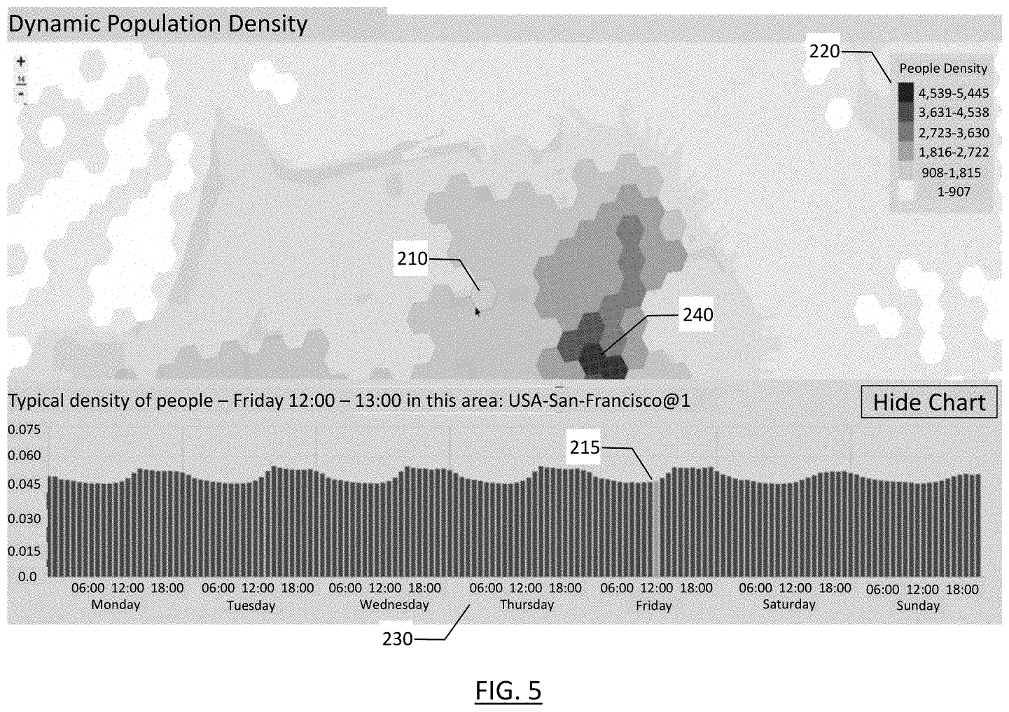

FIG. 5 illustrates interaction with the heat map of FIG. 4, where a specific cell 210 representing a geographic sub-area has been selected, and where a timeline 230 of the dynamic population trend for that cell is illustrated. As shown, the population at the selected time 215 in the timeline 230 is relatively low compared to peak population for that geographic sub-area represented by the cell 210. This may be due to the cell 210 corresponding to a residential sub-area where residents are at work during the time represented by bar 215 of timeline 230. After 3 pm on Friday, the population of cell 210 increases. Also shown in FIG. 5 is a heat-map key 220 that depicts the population density corresponding to the illustrated colors. As shown, the darker colors represent more people, and the highest density cells such as cell 240 may be a location where people are concentrated at the specific time instance selected.

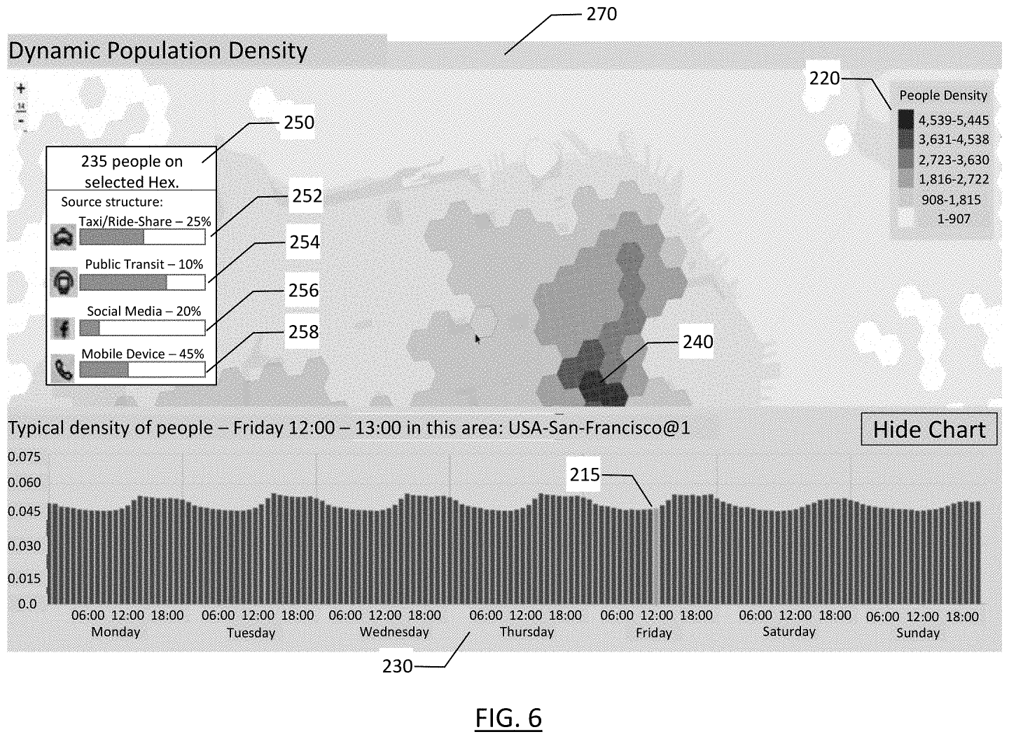

According to some example embodiments, a user interface may include an indication of the source of the dynamic data for a particular cell. FIG. 6 illustrates such an example embodiment in which a window provides an indication of the number of people (235) are within a selected hexagonal sub-area shown at 250. The source structure is shown below as 25% of the dynamic data coming from taxi or ride-share information, 10% coming from public transit, 20% coming from social media, and 45% coming from mobile device positioning. Information such as this may be useful to users of the dynamic population density user interface 270.

Embodiments described herein may be useful for a wide variety of practical implementations, such as for establishing where people are at a given time, or how people move throughout a day. Such information may be beneficial to advertisers so they understand where to target specific advertisements and at what times to do so. Other use cases may include aviation where a city may be sensitive to the noise generated by aircraft approaching and departing an airport due to noise issues. Embodiments may provide an indication of preferred flight paths where flight paths are more desirable to be over less-dense areas. Census data may suggest that populations are static in residential areas. However, embodiments described herein may demonstrate that it is undesirable to fly over businesses or industrial areas during the day, and instead to fly over residential areas of lower population to disrupt the fewest number of people. Embodiments may also be used to plan for emergency services and staffing such that emergency services proximate low population areas at certain times of the day may require lower staffing levels than during times of day in which those same areas have a high population.

Example embodiments provided herein may provide population estimates and predictions of the probability of observing a predetermined amount of people within one or more geographic sub-areas, and may present this information on graphical user interfaces as described above with respect to FIGS. 4-6. The population estimates and predictions may also be queried live by third party systems that support the example use cases described above by an application programming interface such that the population estimates and predictions may be provided to third party systems without necessarily implementing the graphical user interfaces shown.

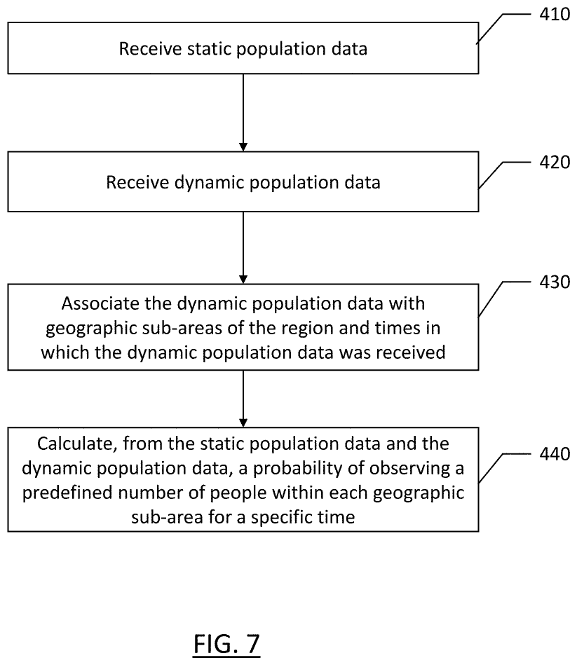

FIG. 7 illustrates a flowchart of a method for identifying a probability of observing a predefined number of people within a geographic sub-area according to an example embodiment of the present disclosure. As shown at 410, static population data is received. Static population data may be population data that is updated no more frequently than a pre-defined frequency, such as a matter of days, weeks, months, or years, for example. Static population data may be received from municipal sources such as a census. Dynamic population data is received at 420 which may include data from a mobile device, vehicle probe data, social media check-in data, traffic data, or camera image data, for example. Dynamic population data is updated more frequently than the predefined frequency. The dynamic population data may be associated with geographic sub-areas of the region and times in which the dynamic population data was received as shown at 430. At 440, a probability of observing a predefined number of people within each geographic sub-area for a specific time is calculated based on the static population data and the dynamic population data.

As described above, FIG. 7 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 7 above may comprise a processor (e.g., the processor 22) configured to perform some or each of the operations (410-440) described above. The processor may, for example, be configured to perform the operations (410-440) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-440 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive static population data comprising a population count associated with each of a plurality of geographical areas of a geographic region, wherein static population data is updated no more frequently than a predefined frequency;
receive dynamic population data for the geographic region including the plurality of geographical areas, wherein dynamic population data is updated more frequently than the predefined frequency;
associate the dynamic population data with geographic sub-areas of the geographic region and times in which the dynamic population data was received; and
calculate, from the static population data and the dynamic population data, a probability of observing a predefined number of people within each geographic sub-area for a specific time.

2. The apparatus of claim 1, wherein the geographical areas do not correspond with the geographic sub-areas, wherein the apparatus is further caused to:
re-associate the static population data from the plurality of geographical areas with the geographic sub-areas, wherein causing the apparatus to calculate, from the static population data and the dynamic population data, probabilities for observing a predetermined number of people within the geographic sub-areas comprises causing the apparatus to calculate, from the static population data re-associated with the geographic sub-areas and the dynamic population data associated with the geographic sub-areas, a probability of observing a predefined number of people within each geographic sub-area.

3. The apparatus of claim 1, wherein the dynamic population data comprises at least one of: mobile device probe data, vehicle probe data, social media check-in data, traffic data, or camera image data.

4. The apparatus of claim 4, wherein the static population data for the geographical areas comprises census data for the geographical areas.

5. The apparatus of claim 1, wherein the apparatus is further caused to:
generate population estimates for the geographic sub-areas based on the probability of observing a predefined number of people within the geographic sub-areas; and
generate a graphical user interface of the geographic region, wherein the graphical user interface presents the geographic sub-areas of the geographic regions and provides an indication of the population estimates for the geographic sub-areas.

6. The apparatus of claim 5, wherein the indication of the population estimates for the geographic sub-areas provides an indication of the specific time of the respective population estimates for the geographic sub areas.

7. The apparatus of claim 1, wherein causing the apparatus to calculate, from the static population data and the dynamic population data, a probability of observing a predefined number of people within each geographic sub-area comprises causing the apparatus to model the population probabilities based on Bayesian processing using Dirichlet modeling of the static population data and the dynamic population data.

8. The apparatus of claim 1, wherein causing the apparatus to receive dynamic population data for a geographic region comprises causing the apparatus to:
receive dynamic population data for the geographic region from a plurality of data sources;
identify dynamic population data representing other than a single person; and
transform the dynamic population data representing other than a single person to correspond to an estimated number of people associated with the dynamic population data representing other than a single person.

9. A computer program product comprising at least one non-transitory computer-readable storage medium having computer-executable program code instructions stored therein, the computer-executable program code instructions comprising program code instructions to:
receive static population data comprising a population count associated with each of a plurality of geographical areas of a geographic region, wherein static population data is updated no more frequently than a predefined frequency;
receive dynamic population data for the geographic region including the plurality of geographical areas, wherein dynamic population data is updated more frequently than the predefined frequency;
associate the dynamic population data with geographic sub-areas of the geographic region and times in which the dynamic population data was received; and
calculate, from the static population data and the dynamic population data, a probability of observing a predefined number of people within each geographic sub-area for a specific time.

10. The computer program product of claim 9, wherein the geographical areas do not correspond with the geographic sub-areas, further comprising program code instructions to:
re-associate the static population data from the plurality of geographical areas with the geographic sub-areas, wherein the program code instructions to calculate, from the static population data and the dynamic population data, probabilities for observing a predetermined number of people within the geographic sub-areas comprises program code instructions to calculate, from the static population data re-associated with the geographic sub-areas and the dynamic population data associated with the geographic sub-areas, a probability of observing a predefined number of people within each geographic sub-area.

11. The computer program product of claim 9, wherein the dynamic population data comprises at least one of: mobile device probe data, vehicle probe data, social media check-in data, traffic data, or camera image data.

12. The computer program product of claim 11, wherein the static population data for the geographical areas comprises census data for the geographical areas.

13. The computer program product of claim 9, further comprising program code instructions to:
generate population estimates for the geographic sub-areas based on the probability of observing a predefined number of people within the geographic sub-areas; and
generate a graphical user interface of the geographic region, wherein the graphical user interface presents the geographic sub-areas of the geographic regions and provides an indication of the population estimate for the geographic sub-areas.

14. The computer program product of claim 13, wherein the indication of the population estimate for the geographic sub-areas provides an indication of the specific time of the respective population estimates for the geographic sub-areas.

15. The computer program product of claim 9, wherein the program code instructions to calculate, from the static population data and the dynamic population data, a probability of observing a predefined number of people within each geographic sub-area comprises program code instructions to model the population probabilities based on Bayesian processing using Dirichlet modeling of the static population data and the dynamic population data.

16. The computer program product of claim 9, wherein the program code instructions to receive dynamic population data for a geographic region comprises program code instructions to:
receive dynamic population data for the geographic region from a plurality of data sources;
identify dynamic population data representing other than a single person; and
transform the dynamic population data representing other than a single person to correspond to an estimated number of people associated with the dynamic population data representing other than a single person.

17. A method comprising:
receiving static population data comprising a population count associated with each of a plurality of geographical areas of a geographic region, wherein static population data is updated no more frequently than a predefined frequency;
receiving dynamic population data for the geographic region including the plurality of geographical areas, wherein dynamic population data is updated more frequently than the predefined frequency;
associating the dynamic population data with geographic sub-areas of the geographic region and times in which the dynamic population data was received; and
calculating, from the static population data and the dynamic population data, a probability of observing a predefined number of people within each geographic sub-area for a specific time.

18. The method of claim 17, wherein the geographical areas do not correspond with the geographic sub-areas, wherein the method further comprises:
re-associating the static population data from the plurality of geographical areas with the geographic sub-areas, wherein calculating, from the static population data and the dynamic population data, probabilities for observing a predefined number of people for the geographic sub-areas comprises calculating, from the static population data re-associated with the geographic sub-areas and the dynamic population data associated with the geographic sub-areas, a probability of observing a predefined number of people within each geographic sub-area.

19. The method of claim 1, wherein the dynamic population data comprises at least one of: mobile device probe data, vehicle probe data, social media check-in data, traffic data, or camera image data.

20. The method of claim 4, wherein the static population data for the geographical areas comprises census data for the geographical areas.
